(19) United States
(12) Patent Application Publication
(10) Pub. No.: US 2012/0040612 A1
(43) Pub. Date: Feb. 16, 2012

(54) SYSTEM AND METHOD FOR MANAGING VEHICLE EXPENDABLES USING AUGMENTED REALITY

(75) Inventors: Jong Bok Lee, Yongin (KR); Soon Hyeng Hwang, Seoul (KR)

(73) Assignee: HYUNDAI MOTOR COMPANY, Seoul (KR)

(21) Appl. No.: 12/956,580

(22) Filed: Nov. 30, 2010

(30) Foreign Application Priority Data
Aug. 13, 2010 (KR) 10-2010-0078239
Aug. 13, 2010 (KR) 10-2010-0078240

(51) Int. Cl. H04B 5/00; H04M 1/00; G09G 5/00

(52) U.S. Cl. 455/41.1; 345/633; 455/556.1

(57) ABSTRACT

A vehicle expendable management system is adapted to manage expendables within a vehicle using an augmented reality technique. The vehicle expendable management system includes: an expendable information storage for storing checking and changing period information for expendables within a vehicle; and an expendable management unit for updating the checking and changing period information for the expendables within the vehicle on the basis of mileage information of the vehicle, and applying the latest checking and changing period information of the expendables to an expendable information providing apparatus using wireless communication. The vehicle expendable management system of the aforementioned configuration updates and provides periods of checking and changing for expendables within a vehicle on the basis of vehicle mileage information. As such, the vehicle expendables can be easily managed.

### CROSS-REFERENCES TO RELATED APPLICATIONS

Priority is claimed to Korean patent application number 10-2010-0078240, filed on Aug. 13, 2010, and 10-2010-0078239, filed on Aug. 13, 2010, which is incorporated by reference in its entirety.

### BACKGROUND

1. Field of the Disclosure

The present invention generally relates to vehicle expendable management system and method, particularly a system and method using augmented reality. More particularly, the present invention relates to a vehicle expendable management system and method adapted to manage checking and changing/replacing period information for expendables within a vehicle based on vehicle mileage information, and adapted to provide the checking and replacing period information for each of the expendables within the vehicle using an augmented reality technique.

2. Description of the Related Art

Augmented reality overlaps virtual objects with the actual world viewed by a user. In other words, augmented reality is a mixed reality because it displays the actual world and the virtual world with additional real-time information in a single image.

Although augmented reality, which conceptually complements the actual world with the virtual world, uses a virtual environment created by a computer graphic technique, the augmented reality appears to become an actual environment. Computer graphic techniques are used to add desired information into the actual environment. As a three-dimensional virtual image overlaps with a real image viewed to users, it is difficult to distinguish the virtual screen from the actual environment.

The virtual reality technique absorbs users in the virtual environment such that the users don't view the real environment. The augmented reality technique, on the other hand, mixes virtual objects with the actual environment and, thus, allows the users to see the actual environment. Therefore, the augmented reality technique can provide the sense of both the real and the additional information. For example, when a camera included in a smart phone takes a photograph of a user's environment, additional information such as positions, phone numbers, etc. for stores and various other things surrounding the user, is displayed in a three-dimensional image.

A variety of applications are currently provided using the augmented reality technique. However, use of the augmented reality technique has not been contemplated for managing the checking and changing/replacing periods for the expendables of a vehicle.

### BRIEF SUMMARY

The present invention is directed to vehicle expendable management system and method that addresses the problems due to limitations and disadvantages of the currently available systems and methods.

An object of the present invention is to provide a vehicle expendable management system and method that are adapted to effectively manage expendables within a vehicle. In particular, the present system and method manages checking and changing period information for the expendables within a vehicle bases on the vehicle mileage information. In particular, the present system and method provides checking and changing period information of the vehicle expendables using an augmented reality technique.

Additional features and advantages of the present invention will be set forth in the description which follows, and in part will be apparent from the description, or may be learned by practice of the present invention. The advantages of the present invention will be realized and attained by the structure particularly pointed out in the written description and claims hereof as well as the appended drawings.

To achieve the aforementioned object, a vehicle expendable management system according to an embodiment of the present invention includes: an expendable information storage for storing checking and changing period information for each of the expendables within a vehicle; and an expendable management unit for updating the checking and changing period information for each of the expendables within the vehicle on the basis of mileage information of the vehicle, and for applying the latest checking and changing period information of the expendables to an expendable information providing apparatus in a wireless communication system.

To achieve the aforementioned object, a vehicle expendable management method according to another embodiment of the present invention includes: storing checking and changing period information for each of the expendables within a vehicle; updating the checking and changing period information for each of the expendables within the vehicle on the basis of mileage information of the vehicle; and applying the latest checking and changing period information of the expendables to an expendable information providing apparatus of the vehicle using a wireless communication.

To achieve the aforementioned object, a vehicle expendable management method according to still another embodiment of the present invention includes: receiving checking and changing period information for each of the expendables within a vehicle from a vehicle expendable management apparatus; generating an augmented reality image in which the checking and changing period information is inserted onto each of the expendable regions identified by an augmented reality technique; and displaying the augmented reality image on a screen.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the embodiments and are incorporated in and constitute a part of this application, illustrate embodiment(s) of the invention and together with the description serve to explain the disclosure. In the drawings:

FIG. 1 is a configuration diagram showing a vehicle expendable management system using augmented reality according to an embodiment of the present invention;

FIG. 2 is an exemplary diagram showing an augmented reality image according to the present invention; and

FIG. 3 is a flow chart illustrating a method of managing expendables within a vehicle using augmented reality according to an embodiment of the present invention.

### DETAILED DESCRIPTION

The above objects, features and advantages will be, or will become, apparent to one with skill in the art upon examination of the following figures and detailed description. As such, technical subject matters of the present invention can be easily implemented by one with skill in the art. Also, in the description of the present invention, the related art, which is known to one with skill in the art, to the present invention will be omitted in case that there is possibility that it makes the subject matter of the present invention to be indistinct without necessity. Reference will now be made in detail to the embodiments of the present invention, examples of which are illustrated in the accompanying drawings.

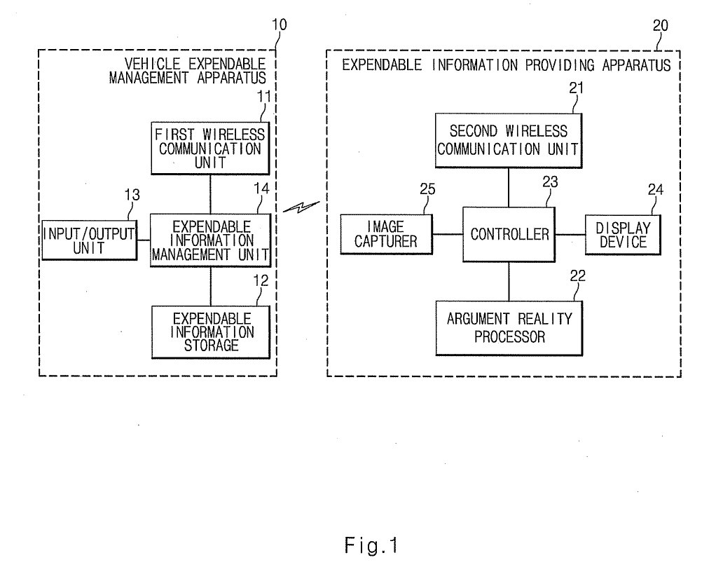

FIG. 1 is a configuration diagram showing a vehicle expendable management system using augmented reality according to an embodiment of the present invention. In particular, as shown in FIG. 1, the vehicle expendable management system using augmented reality according to an embodiment of the present invention includes a vehicle expendable management apparatus 10 and an expendable information providing apparatus 20. The vehicle expendable management apparatus 10 is not particularly limited and can be, for example a CUbiS (Car Ubiquitous System). The expendable information providing apparatus 20 is also not particularly limited and can be, for example, a portable terminal.

The vehicle expendable management apparatus 10 is mounted to a vehicle and is configured to manage information for expendables within the vehicle. For example, the information may include checking and replacing periods of the expendables on the basis of mileage information of the vehicle. The vehicle expendable management apparatus 10 communicates with the expendable information providing apparatus 20 so as to transmit the managed information (hereinafter, “vehicle expendable information”) for the expendables within the vehicle to the expendable information providing apparatus 20.

The expendable information providing apparatus 20 receives the vehicle expendable information from the vehicle expendable management apparatus 10. In a preferred embodiment, the expendable information providing apparatus 20 displays the vehicle expendable information on regions of the corresponding expendables within an image, which can be obtained by a camera or other suitable known means, using an augmented reality technique.

The components as described above will be explained in further detail in connection with one preferred embodiment. The vehicle expendable management apparatus 10 is linked to a mileage information management apparatus within the vehicle so as to obtain the mileage information (or travel distance information) of the vehicle. Such a vehicle expendable management apparatus 10 generally includes a first wireless communication unit 11, an expendable information storage 12 (hereinafter sometimes referred to as “storage 12”), an input/output unit 13, and an expendable information management unit 14.

The first wireless communication unit 11 is configured to communicate with the expendable information providing apparatus 20 in a Bluetooth communication system or a near field communication system. In particular, the first wireless communication unit 11 transmits the vehicle expendable information stored in the expendable information storage 12 to the expendable information providing apparatus 20, and receives expendable change information from the expendable information providing apparatus 20, depending on the control of the expendable information management unit 14. The expendable change information is used to update the checking and changing periods of the vehicle expendables. Also, the first wireless communication unit 11 transmits and receives data for validating the expendable information providing apparatus 20.

The storage 12 is configured to store the information regarding the checking and changing periods for the expendables within the vehicle, for example as specified in Table 1 which is one example and is prepared as follows. In Table 1, the checking and changing periods for each of the vehicle expendables is calculated on the basis of a mileage (or a travel distance) which is checked to determine the changing time of the respective expendable.

Thus, for example, looking at Table 1, if the current mileage of the vehicle is 0 Km, the checking period shows that the engine oil must be checked when the mileage reaches 5,000 Km. Further, the changing period indicates that the engine oil must be replaced when the mileage reaches 10,000 Km.

Alternatively, as shown in Table 1, if it is assumed that the current mileage is 15,000 Km, the engine oil must be next checked at 20,000 Km (because the engine oil must be checked every 5,000 Km as shown in Table 1). Further, according to the engine oil changing period, the engine oil must be replaced at 20,000 Km (because the engine oil must be replaced every 10,000 Km as shown in Table 1).

TABLE 1

| | Checking period (Km) | Changing period (Km) |
|---|---|---|
| Engine oil | 5,000 | 10,000 |
| Battery | 20,000 | 50,000 |
| Spark plug | 20,000 | 40,000 |
| Plug wires | 25,000 | 40,000 |
| Brake pads | 10,000 | 30,000 |
| Tires | 35,000 | 35,000 |
| Transmission oil | 30,000 | 30,000 |
| Fan belts | 25,000 | 40,000 |
| Timing belt | 40,000 | 60,000 |

It is understood that the checking and changing periods of the vehicle expendables specified in the Table 1 are only examples, and can vary, for example, from one vehicle type to the next. Also, Table 1 specifies only some expendables within a vehicle, and the list of expendables provided is not exhaustive.

According to an embodiment, an example of the input/output unit 13 employed can be an AVN (Audio Video Navigation). However, this is only one example, and other suitable input/output units known in the art could suitably be employed. The input/output unit 13 replies to a demand from a vehicle driver and displays the vehicle expendable information on its screen. When the driver replaces any one of the expendables with a new one, the input/output unit 13 inputs the expendable changing information in order to update the checking and changing periods for the respective expendable. In other words, whenever the expendable is checked or replaced/changed, the vehicle driver inputs corresponding information so that the expendable information management unit 14 updates the checking and changing periods for the respective expendable with the latest information.

According to various embodiments of the present invention, the expendable information management unit 14 controls the first wireless communication unit 11, storage 12 and input/output unit 13. In particular, the expendable information management unit 14 is linked to the mileage information management apparatus within the vehicle so as to collect the mileage information of the vehicle. The expendable information management unit 14 updates the checking and changing periods for each of the expendables within the vehicle on the basis of the collected mileage information. The expendable information management unit 14 can then provide the updated information to the vehicle driver through the input/output unit 13.

The expendable information management unit 14 can further uses the expendable checking and changing information input by the vehicle driver and update the checking and changing periods of the respective expendables which are stored in the storage 12. For example, if the mileage of the vehicle is 30,000 Km when transmission oil is replaced, all the checking and changing periods of the transmission oil in Table 1 will be updated to 60,000 Km (because the change period is 30,000 Km). When the changing or changing period for any one of the expendables within the vehicle nears, the expendable information management unit 14 can provide the vehicle driver with a checking or changing alarm, informing the driver that the corresponding expendable must be checked or replaced/changed, e.g. through the input/output unit 13. As such, the vehicle driver can easily manage the expendables within the vehicles.

Moreover, the expendable information management unit 14 can be further configured to perform a validating process and apply the expendable checking and changing information to the expendable information providing apparatus that is normally validated, such as through communication with the expendable information providing apparatus 20 in the bluetooth communication system or the near field communication system. As such, the expendable information management unit 14 can prevent its vehicle information from being provided to other people without the vehicle driver.

In some embodiments, the expendable information providing apparatus 20 includes a second wireless communication unit 21, an augmented reality processor 22, a controller 23, a display device 24, and an image capturer 25, such as a camera, configured to take an image of the vehicle expendables.

The second wireless communication unit 21 can communicate with the vehicle expendable management apparatus 10, such as in the bluetooth communication system or the near field communication system. More specifically, the second wireless communication unit 21 can transmit and receive authentic data to and from the vehicle expendable management apparatus 10. Also, the second wireless communication unit 21 can receive the checking and changing period information for the expendables within the vehicle from the vehicle expendable management apparatus 10. Furthermore, the second wireless communication unit 21 can supply the vehicle expendable management apparatus 10 with the expendable checking and changing information which is used to update the checking and changing periods of the expendables.

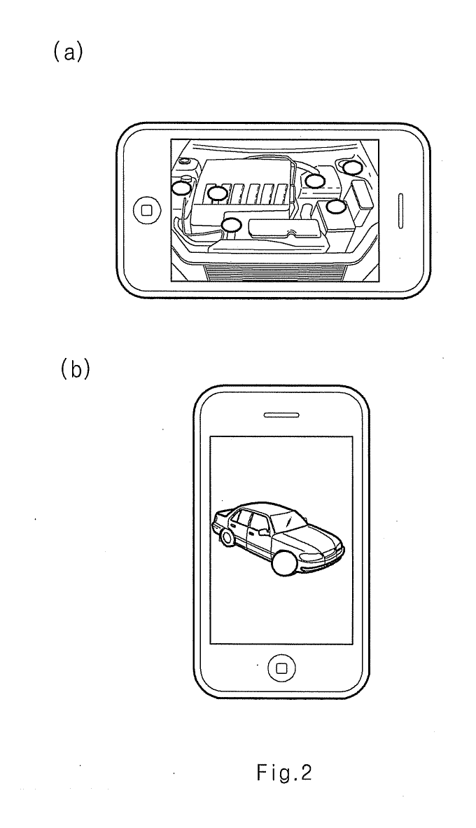

According to various embodiments of the present invention, the augmented reality processor 22 generates an augmented reality image using an augmented reality technique. In particular, the augmented reality processor 22 can identify the vehicle expendables on an image, which is obtained by the image capturer 25, and inserts the checking and changing period information onto regions of the image corresponding to the respective vehicle expendables. The augmented reality image can be, for example as shown in FIG. 2. As shown in FIG. 2, the checking and changing periods are displayed on elliptical regions of the augmented reality image.

According to an embodiment of the present invention, the augmented reality processor 22 using the augmented reality technique can display either titles of the vehicle expendables or the checking and changing period information on the elliptical regions of the augmented reality image corresponding to the vehicle expendables, after identifying vehicle expendables on the obtained image. In case that the titles of the vehicle expendables are displayed, when any one of the titles displayed on the display device with a touch pad function is touched by a user (i.e., the vehicle driver), the controller 23 provides the checking and changing period information for the touched title as detailed information.

According to an embodiment of the invention, in order to identify the vehicle expendables, the augmented reality processor 22 can associate with a three-dimensional geometry database having the vehicle expendable information. The three-dimensional geometry database can store three-dimensional geometrical structure, lengths, shapes, colors, etc. for each of the expendables. The three-dimensional geometrical structure for each of the expendables can be previously scanned by a three-dimensional scanner or other suitable scanning means and stored in the three-dimensional geometry database.

Among the vehicle expendables, the kinds of oil can be identified by injection portions of their containers because they are not fixed in shape and are not exposed to the exterior. Also, some of the expendables which are located at regions which cannot be photographed due to being shielded (e.g. with other objects), can be displayed together with their peripheral expendables when the peripheral expendables are identified. For example, a brake pad can be displayed together with a tire when the tire is identified.

According to various embodiments, the controller 23 controls the second wireless communication unit 21, augmented reality processor 22, display device 24, and the image capturer 25. Particularly, the controller 23 controls the augmented reality processor 22 to generate the augmented reality image. The augmented reality image includes the checking and changing period information of the expendables which can be received, for example, through the second wireless communication unit 21 or stored in a storage (not shown in the drawings) after being received through the second wireless communication unit 21.

The display device 24 is preferably configured to have a touch screen function. As such, the display device 24 displays not only the augmented reality image provided by the augmented reality processor 22, but also detailed information for a user using the touch screen function.

An embodiment of the augmented reality processor 22 will now be described in more detail. The augmented reality technique is implemented in this embodiment using an algorithm specified below, in order to provide management information for each of the expendables within the vehicle to the vehicle driver.

Although it is not shown in the drawings, the augmented reality processor 22 can include a parallel processor circuit and a tracer (such as used in the art). The parallel processor circuit can include first and second processors.

According to an embodiment of the present invention, the first processor processes an image of the vehicle expendables, which can be photographed by a camera (i.e., the image capturer 25), and calculates the coordinate values of camera markers, projective matrix values, and surface normal values. The coordinate values of the camera marker corresponds to an intersection, which is projected in the camera, between edges representing an image of the expendable. The projective matrix values are used to display the image of the expendable photographed by the camera on a screen. The surface normal vector values are used to depict triangles included in a polypyramid which is generated by connecting a central point with the intersections.

The tracer included in the augmented reality processor 22 can be configured not only to trace the configuration and position of each expendable on the basis of the coordinate values of the markers, projective matrix values and surface normal values, but also to generate three dimensional informative-data. The tracer can further be configured to include a compensator. The compensator can be provided to compensate errors between the configuration and position of the traced expendable and the configuration and position of the real expendable, and generates the three dimensional informative data. In some embodiments, the compensator can be externally separate from the tracer. For example the compensator can receive the configuration and position information of the traced expendable from the tracer, in order to not only compensate errors between the configuration and location of the traced expendable as compared with the real expendable but also generate the three dimensional informative data.

The second processor included in the parallel processor circuit can receive the three dimension informative data and vertex data for a target image model, which appears together with the expendable in a three dimensional virtual space. The second processor can further perform a rendering process for the received three dimensional informative data and vertex data, and generate an augmented reality image including the expendables and target image model image which appear in the shape of a three dimensional virtual image.

In accordance with various embodiments, it can generally be that a three dimensional image has been divided into a plurality of polygons. For example, it can be assumed that a three dimensional image is made up of a plurality of triangles, the vertex corresponds to the apex of a triangle and the vertex data can become information including position and color of the vertex. In this case, the second processor which receives the vertex data can perform a process of connecting the vertexes and of determining a color of the vertex at a pixel or fragment level.

Such a parallel processor circuit and tracer can be operated by the controller 23. For example, the controller 23 can disable the tracer, such that is not operated, while the parallel processor circuit is operated. The controller 23 can also disable the parallel processor circuit while the tracer is operated. In other words, the controller 23 can control the parallel processor circuit and the tracer to be independently activated and non-activated.

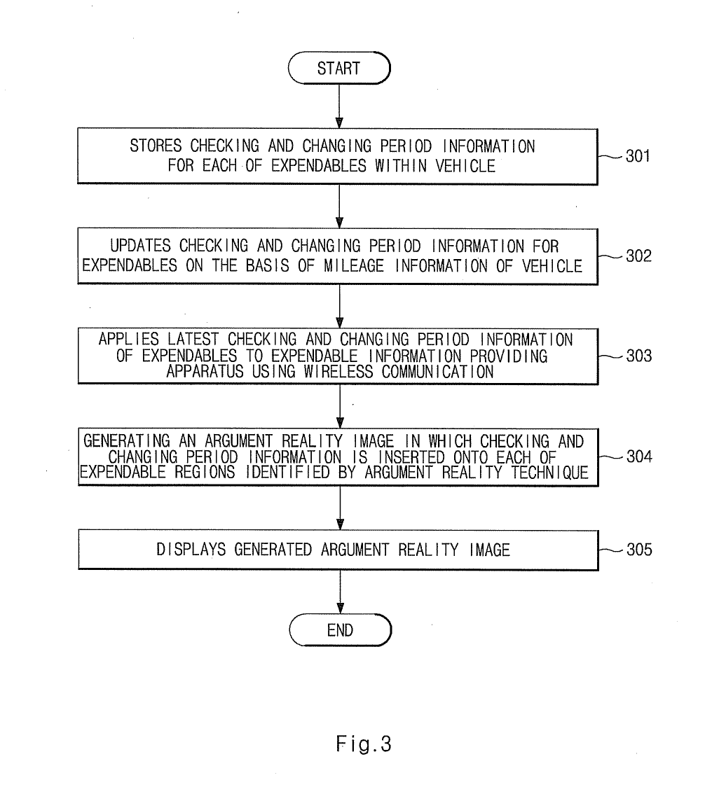

FIG. 3 is a flow chart illustrating a method of managing expendables within a vehicle using augmented reality according to an embodiment of the present invention.

As shown, the vehicle expendable management apparatus 10 first stores the checking and changing period information for each of the expendables within the vehicle (step 301). To this end, the vehicle expendable management apparatus 10 can be driven in such a manner as to associate with an ECU (Engine control unit) and so on. In addition to the checking and changing period information for each of the expendables within the vehicle, the vehicle expendable management apparatus 10 also collects the mileage information of the vehicle.

Subsequently, the vehicle expendable management apparatus 10 updates the checking and changing period information of the expendables on the basis of the mileage information of the vehicle (step 302).

The vehicle expendable management apparatus 10 can then appliy the latest checking and changing period information to the expendable information providing apparatus 20, for example by performing a wireless communication (step 303).

Then, the expendable information providing apparatus 20 generates the augmented reality image using the augmented reality technique (step 304). To this end, the expendable information providing apparatus 20 identifies the expendables on an image and inserts the checking and changing period information onto regions of the image corresponding to the identified expendables.

Thereafter, the expendable information providing apparatus 20 displays the generated augmented reality image on a screen (i.e., the display device 24) (step 305).

As such, the vehicle driver can obtain the checking and changing period information for each of the expendables within his own vehicle from the screen of the expendable information providing apparatus 20. Therefore, the vehicle driver can easily manage every expendable within the vehicle.

Although the above description of the present invention is directed towards managing the expendables within a vehicle, the present invention can be applied to manage other components of the vehicle (e.g. components having longer usage times than those of the expendables). Hereinafter, the present invention as it relates to one embodiment of the management of the vehicle components will be described in detail.

First, the vehicle expendable management apparatus 10 is mounted or disposed in a vehicle and the vehicle driven in such a manner as to associate with a vehicle fault diagnosis system (such as a Mozen telematics system). The vehicle expendable management apparatus 10 manages fault information of the vehicle components and transmits the managed fault information for the vehicle components to the expendable information providing apparatus 20 (e.g. by performing a wireless communication with the expendable information providing apparatus 20). The vehicle fault diagnosis system can be configured to include a telematics center server and can be operated in such a manner as to associate with a vehicle control apparatus, thereby diagnosing the vehicle.

The vehicle control unit can include an engine control unit ECU, a motor control unit MCU, a transmission control unit TCU, a battery management unit BMU, and a full auto temperature controller FATC. The engine control unit ECU is configured to control the overall operation of an engine. The motor control unit MCU is configured to control the overall operation of an electrical motor. The transmission control unit TCU is configured to control a transmission. The battery management unit BMU is configured to manage the operation of a battery. The full auto temperature controller FATC is configured to control the temperature inside the vehicle.

The expendable information storage 14 can be configured to store fault information for the vehicle components which are sorted into detailed component groups within broader component groups. For example, the large component groups may include an engine component group, a braking component group, a transmission component group, and so on.

In an exemplary embodiment, if a fuel shut-off valve fails, the stored fault information can include the following:
1. A fault content of “This error in the vehicle is related to the engine. It is expected that the wirings related to a fuel shut-off value corresponding to an important electrical component is shorted or disconnected. After the start operation of the vehicle is turned-off, a fault is generated in a fuel shut-off device. In order to secure the safety of driver and protect the vehicle, please ask a nearby vehicle service center or repair center to repair or check the vehicle.” or “It seems that this non-normal phenomenon is caused by a short circuit or a disconnection in the wirings of a fuel shut-off valve which corresponds to an important electrical component. In order to secure the safety of driver and protect the vehicle, please ask a nearby vehicle service center or repair center to repair or check the vehicle”.
2. A fault factor of “It is expected that either the performance of the fuel shut-off valve will deteriorate, or the fuel shut-off valve will fail”; and
3. A function of the failed component specified as “It is a device used to shut off a fuel line between a fuel tank and an injector”.

Alternatively, when a brake disk within a brake device fails, the stored fault information can includes the following:
1. A fault content of “This error in the vehicle is related to a vehicle body pose control unit. A TCS alarm light on a fascia board is blinking and the vehicle body pose control unit is turned off. In this case, an ABS brake normally operates not to affect a braking function. However, the TCS alarm light will be turned-off and the system will become normal when the brake system has a normal temperature. If the TCS alarm light is not turned-off continuously, please ask a nearby vehicle service center or repair center to repair or check the vehicle, in order to secure the safety of driver and protect the vehicle.” or “It seems that this error in the vehicle is related to a vehicle body pose control unit. A TCS alarm light on a fascia board is turned-on. If the TCS alarm light is not turned-off, please ask a nearby vehicle service center or repair center to repair or check the vehicle, in order to secure the safety of driver and protect the vehicle” as a summarized manner.
2. A fault factor of “It is expected that either a brake device is overheated, or wirings for applying electrical power to an anti lock brake system and a body pose control apparatus are shorted, disconnected or poorly connected.”; and
3. A function of the failed component specified as “This component is used to control an anti lock brake system (ABS) and a traction control system (TCS).”

The fault information can be changed as needed according to, for example, the type of vehicle. The types of components described above correspond to components within an exemplary vehicle.

According to embodiments of the present invention, the augmented reality processor 22 uses an augmented reality technique. Such an augmented reality processor 22 is configured to identified the vehicle components on an image and generate an augmented reality image with the fault information which is displayed in regions of the image corresponding to the identified vehicle components. For example, when an engine on the image is identified, the augmented reality processor 22 displays an image and the fault information for a fault component within the engine.

Further, the present augmented reality processor 22 using the augmented reality technique can display either the fault information or titles of the vehicle components on regions of the augmented reality image corresponding to the vehicle components, after identifying the types of vehicle components on the obtained image. In a case where the titles of the vehicle expendables are displayed, when any one of the titles displayed on the display device with a touch pad function is touched by a user (i.e., the vehicle driver), the controller 23 provides the fault information for the touched title as detailed information.

In order to identify various types of the vehicle components, the augmented reality processor 22 can associate a three-dimensional geometry database having vehicle component information. The three-dimensional geometry database stores three-dimensional geometrical structures, length, shape, color, and so on for each of the vehicle components. The three-dimensional geometrical structure, length, shape, color, and so on for each of the expendables can be previously obtained using a three-dimensional scanner or other suitable scanning means, and stored in the three-dimensional geometry database.

On the other hand, if a vehicle in the image is identified, the augmented reality processor 22 can display collectively the images of fault components and the fault information on a region of the identified vehicle.

As shown in FIG. 1, the controller 23 controls the second wireless communication unit 21, augmented reality processor 22, display device 24, and the image capturer 25. In particular, the controller 23 controls the augmented reality processor 22 to generate the augmented reality image. The augmented reality image includes the fault information of the vehicle components which can be received through the second wireless communication unit 21, or stored in a storage (not shown in the drawings) after being received through the second wireless communication unit 21.

A method according to the present invention can be provided in some embodiments in a computer program. Code words and segments included in the program can be readily determined by computer-programmers skilled in the art. The provided program can be stored in a computer-readable record medium (an information storing medium). As such, the program stored in the record medium can be read and executed by a computer so that the method according to the present invention can be implemented. The record medium is not particularly limited, and can be, for example, in accordance with conventional computer-readable record mediums.

As described above, the present invention manages checking and changing period information for the expendables within a vehicle on the basis of vehicle mileage information. Also, the present invention provides the checking and changing periods for each of the expendables within the vehicle using an augmented reality technique. Therefore, the present invention can effectively manage the expendables within the vehicle.

Moreover, as the vehicle expendables are effectively managed, the present invention can cut expenses caused by unnecessarily changing the expendables.

It will be apparent to those skilled in the art that various modifications and variations can be made within a scope being not out of the technical subject matter of the present invention. Thus, it is intended that the present invention cover the modifications and variations of this invention provided they come within the scope of the appended claims and their equivalents.

What is claimed is:

1. A vehicle expendable management apparatus comprising:
an expendable information storage configured to store checking and changing period information for expendables within a vehicle; and
an expendable management unit configured to update the checking and changing period information for each of the expendables within the vehicle on the basis of mileage information of the vehicle, and to apply the latest checking and changing period information of the expendables to an expendable information providing apparatus using wireless communication.

2. The vehicle expendable management apparatus of claim 1, wherein the expendable management unit receives checking and changing information of the expendables from the expendable information providing apparatus and updates the checking and changing period information for the expendables.

3. The vehicle expendable management apparatus of claim 1, further comprising an input/output unit configured to display information for an expendable on a screen and to directly receive expendable checking and changing information, which is used for updating the checking and changing periods of the expendables.

4. The vehicle expendable management apparatus of claim 1, wherein the wireless communication includes Bluetooth communication technology and near field communication technology.

5. The vehicle expendable management apparatus of claim 1, wherein the expendable information providing apparatus includes:
a wireless communication unit configured to receive the checking and changing period information for the expendables from the expendable information management apparatus;
an augmented reality processor configured to identify the expendables on a image using an augmented reality technique and to generate an augmented reality image in which the checking and changing period information is inserted onto regions of the image corresponding to the identified expendables;
a display device configured to display the augmented reality image; and
a controller configured to transmit the checking and changing period information for each of the expendables within the vehicle to the augmented reality processor and to control the display device to display the augmented reality image.

6. The vehicle expendable management apparatus of claim 5, wherein the controller configured to transmit expendable checking and changing information input from a user to the expendable information management unit through the wireless communication.

7. The vehicle expendable management apparatus of claim 5, wherein the wireless communication communicates with the expendable information management apparatus in a Bluetooth communication technology and a near field communication technology.

8. The vehicle expendable management apparatus of claim 5, wherein the expendable information management unit receives checking and changing information of the expendables from the expendable information providing apparatus in the wireless communication and updates the checking and changing period information for the expendables.

9. The vehicle expendable management apparatus of claim 5, further comprises an input/output unit configured to display information for an expendable required by a user on a screen and to directly receive expendable checking and changing information, which is used for updating the checking and changing periods of the respective expendable.

10. A vehicle expendable management method comprising:
storing checking and changing period information for one or more expendables within a vehicle;
updating the checking and changing period information for each of the expendables within the vehicle on the basis of mileage information of the vehicle; and
applying the latest checking and changing period information of the expendables to an expendable information providing apparatus of the vehicle using wireless communication.

11. The method of claim 10, further comprising receiving expendable checking and changing information from the expendable information providing apparatus of the vehicle using the wireless communication to re-update the checking and changing periods of the respective expendable.

12. A vehicle expendable management method comprising:
receiving checking and changing period information for one or more expendables within a vehicle from a vehicle expendable management apparatus;
generating an augmented reality image in which the checking and changing period information is inserted onto each of the expendable regions identified by an augmented reality technique; and
displaying the augmented reality image on a screen.

13. The method of claim 13, further comprising transmitting expendable checking and changing information input by a user to the vehicle expendable management apparatus using the wireless communication.
